(19) United States
(12) Patent Application Publication
(10) Pub. No.: US 2019/0183142 A1
(43) Pub. Date: Jun. 20, 2019

(54) SHELF STABLE ALCOHOLIC BEVERAGE

(71) Applicant: Michael Bleile, Osage Beach, IL (US)

(72) Inventor: Michael Bleile, Osage Beach, IL (US)

(21) Appl. No.: 15/847,956

(22) Filed: Dec. 20, 2017

(51) Int. Cl. A23G 9/04; A23G 9/32

(52) U.S. Cl. CPC A23G 9/04; A23G 9/32; A23V 2300/24; A23V 2250/082; A23V 2002/00

(57) ABSTRACT

The invention is a method for producing a shelf-stable alcoholic wine product and products produced using the method. The method include heating a mixture of ice cream mix, alcohol and water to 170-180° F. for at least 5-9 minutes prior to adding alcohol to the mixture.

### BACKGROUND

### Field of the Invention

This invention is related to desert products that are shelf-stable, and methods of making and using the same. More specifically, the invention is related to alcohol-infused ice cream beverages, which are shelf-stable and able to retain the freshness of the alcohol products infused therein.

### Description of the Related Art

Methods of making ice cream products and beverages are known. Generally, ice cream is flavored with products that are able to withstand production processes that involve pasteurization, homogenization, cooling and refrigeration. Ice cream production methods are described in US Patent Nos. 2550656A and 6685977B1 and RU2218805. While products exist that combine ice cream with wine, these products are unstable at room temperature, which hinders widespread adoption. The products produced using known methods, particularly the methods described in RU2218805, are unsafe for human consumption. In order to produce ice cream flavored with wine, prior art methods pasteurized an ice cream mixture, homogenized it, and then added the alcohol. The resulting beverages produced included alcohol that was contaminated with pathogens and thereby unsafe for storage, unstable at room temperature, and not edible.

Others have attempted to create shelf-stable ice cream products that are actually infused with alcoholic beverage, like red or white wine. They have failed, however, because the processes used in making those products resulted either in destabilization of the alcohol, i.e. it evaporated leaving little to no alcohol in the beverage, or the resulting products lacked shelf stability because the pathogens found in the alcohol product caused spoilage.

What differentiates the present invention is a novel process of producing an ice cream product that is shelf stable. The methods of the invention are able to remove pathogens from the alcohol by subjecting the ice cream mixture containing alcohol to a pasteurization process at a very specific temperate for a very specific amount of time. The temperature maintained is high enough to kill the pathogens in the resulting product, but low enough to prevent evaporation of the alcohol.

### SUMMARY

These and other objects of the invention are addressed by the methods and products of the invention. In one object, a method for producing a shelf-stable alcoholic ice cream product includes mixing water, an ice cream product, and an alcoholic beverage together to produce a mixture, and heating the mixture to a temperature in the range of about 170-177° F. for a minimal time sufficient to produce a shelf-stable alcoholic ice cream product.

In another object, a shelf-stable alcoholic ice cream product is described that includes a mixture of water, an ice cream product, and at least one alcoholic beverage.

In yet another object, a shelf stable alcoholic infused ice cream product includes a mixture of water, a gelato mix, red wine with an alcohol content of about 16% by volume, other flavorants, white wine with an alcohol content of about 16% by volume, whereby the product is shelf-stable, includes an alcohol content in the range of about 5.5-9.5% by volume, and includes about 33% water, about 33% gelato mix, and about 33% total wine content.

In one further object, a method for producing a shelf-stable alcoholic ice cream product consists essentially of mixing water, an ice cream product, and an alcoholic beverage together to produce a mixture, and heating the mixture to a temperature in the range of about 170-180° F. for about 7 minutes to produce a shelf-stable alcoholic ice cream product.

### BRIEF DESCRIPTION OF THE DRAWINGS

Not applicable.

### DETAILED DESCRIPTION

In one embodiment of the invention, processes of producing shelf-stable alcoholic ice cream products comprise mixing water, an ice cream product and an alcoholic beverage to produce a mixture. In accordance with various embodiments of the invention, the mixture is then pasteurized or heated to kill microbes, including bacteria within the mixture, to prevent spoilage and souring of the resulting product. The mixture is heated to a temperature of about 170-180° F. Laboratory testing has revealed that alcohol begins to evaporate at temperatures about 177° F., so in order to maintain the desired alcohol content level, temperatures above 180° F. must be avoided. At 177° F., some of the alcohol content evaporates from the mixture, but the quick heating time necessary to produce a shelf-stable product preserves the alcohol content sufficiently to produce an adequately flavored alcoholic ice cream beverage product.

In specific embodiments of the invention, the pH of the mixture is adjusted prior to the heating step so that it is 4.2 or less. Ideally, and in a specific embodiment of the invention, the products of the invention have a maximum equilibrium pH of about 3.9. Reducing the pH of the product prior to pasteurization prevents any spores from germinating or growing within the mixture, which extends shelf-life.

In certain embodiments additional flavorants may be added to the mixture prior to the heating step. In a specific embodiment of the invention sugar is added to the mixture before it is heated for pasteurization. It should be understood by those of skill in the art that any flavorant may be employed in accordance with the invention.

Before now, no one has successfully combined milk products and alcohol to produce a shelf-stable product due to the wide range of temperatures required to stabilize each product. The inventors have discovered that many alcoholic beverages, including wine, begin to evaporate at temperatures above about 170° F., but are not sufficiently free of microbes below that temperature. As such, and in accordance with the methods of the invention, the mixture is pasteurized, also referred to herein as “heated,” at temperatures in the range of about 170-180° F. for a time sufficient to allow adequate microbial death to occur within the entire mixture, rendering the resulting alcoholic ice cream beverage product safe for storage and consumption. In accordance with the various embodiments of the invention, the heating time is in the range of about 5-9 minutes. In specific embodiments of the invention, the mixture is heated at about 177° F. for about 7.5 minutes. The chart below illustrates temperature and hold times in various embodiments of the methods of the invention. The chart represents the minimum temperatures and hold times that the coolest point within the product must achieve prior to filing of the containers with the claimed beverages and capping those containers.

Temperature (° F.)

| | 170 | 175 | 180 | 185 |
|---|---|---|---|---|
| Time | 450 | 220 | 107 | 52 |
| (seconds) | | | | |

As used herein, sufficient microbial death is evidenced when the microbial count is low enough within the resulting product to prevent spoiling or souring of the product in the absence of refrigeration. As used herein being “shelf-stable” means having sufficient microbial death within the product to provide a minimum 5-log reduction of vegetative pathogens in the product on the interior surface of the packaging or container.

One key feature in the claimed methods and products is the pasteurization of both the ice cream product as well as the alcoholic beverage product simultaneously. Prior art methods have failed to pasteurize the mixture after the alcohol was introduced, which resulted in a product that was unsafe to consume and store. The current methods subject both the alcohol and the ice cream mixture to the extreme temperatures necessary to reduce the microbial count to a level sufficient to ensure safe storage and consumption. Alcohol is not introduced after pasteurization has occurred.

Prior art methods used homogenation and freezing after pasteurization. Homogenation is not employed in the current methods of the invention as it is an unnecessary step. Since the desired products produced by the methods described herein are beverages, there is no further need for freezing after the claimed products are bottled or placed in a container for storage. As such, freezing is not a step employed with the methods claimed and described herein.

As used herein, the ice cream product is any dairy or non-dairy ice cream product, including, but not limited to ice cream mix, non-dairy ice cream mix, gelato, gelato mix, dessert mix, or the like. Further, and in accordance with the various methods of the invention described herein, the resulting ice cream product produced by the methods described herein, may be at least one of a liquid beverage, gelato, deserts, or the like.

As used herein, and in various embodiments of the invention, alcoholic beverages include any red wine, any white wine, any sweet wine product, brandy, a fortified wine spirit, and any other product capable of pasteurization at 170° F. when mixed or combined with an ice cream product as defined herein. The term alcoholic beverage does not include food stabilizers, additives, or the like, that may contain alcohol. In specific embodiments of the invention, at least one red wine is employed in the claimed methods and products. In other specific embodiments of the invention, at least one white wine is employed in the claimed methods of the invention. In yet other embodiments, both red wine and white wine are employed in the methods and products of the invention.

In a specific embodiment of the invention the alcoholic product is a sweet wine. Those of skill in the art understand that any sweet wine may be used in accordance with the invention. As used herein, a sweet wine is any wine having an alcohol content in the range of about 12-22% by volume. Sweet wine often includes brandy or at least one fortified wine spirit to increase alcohol content. As such, both brandy and fortified wine spirits are envisioned to be within the scope of this invention. It should be understood that any sweet wine is suitable for use in the methods and products of the invention.

In a more specific embodiment of the invention, the white wine has an alcohol concentration of at least about 16% by volume, alcohol. In a more specific embodiment of the invention, the red wine has an alcohol concentration at least about 16% by volume, alcohol. In other embodiments of the invention, the alcohol product has a concentration in the range of about 12-22% by volume. One interested in freezing the products of the invention having an alcohol content in this range would require temperature levels so low that a commercial grade freezer would be required. And, when the resulting product froze, it would be icy and not pleasing to the pallet. The claimed methods produce a product that is a liquid beverage able to be safely and conveniently stored on a shelf.

In a specific embodiment of the invention, the method includes producing the mixture defined herein, heating the mixture to at least about 170-177° F., heating containers adapted to accept the mixture to 170° F., and holding the mixture at 170° F. for about 7.5 minutes to produce the shelf-stable ice cream products of the invention. The container and the shelf-stable product produced are then cooled, but not frozen.

In accordance with the methods of the invention, the mixtures are combined at room temperature using any mixing means, including, but not limited to a high shear mixer. The resulting shelf-stable product is not mixed again after it is heated or placed into a container. Once placed in a container, which in specific embodiments is a bottle, the container is heated for at least 7.5 minutes and then cooled. Any container suitable for storing alcoholic beverages may be employed in accordance with the invention, including but not limited to a bottle, or foil pouch.

In one exemplary embodiment of the invention, Seven Springs Red Heaven wine is mixed, for about 30 minutes, with water in an approximately 3:1 ratio. Citric acid is used to adjust the pH of the mixture to less than 3.9. A dry, soft-serve non-dairy ice cream mix is added to the mixture in an amount that is roughly half of that of the wine. Granulated sugar is also added to taste. The mixture is then heated to about 177° F. The resulting shelf-stable mixtures is then poured into bottles that have been heated to a minimum of 170° F. A cap is then immediately placed over the bottles. The filled bottles are then heated for about 8 minutes at 170° F., and then cooled. A shelf-stable ice cream beverage is produced that has a pH in the 3.85+/−0.05 and about 7-8% alcohol by volume.

The methods, products, and various embodiments described herein are illustrative and should not limit the scope of the claims. It will be understood by those of ordinary skill in the art that modifications may be made to the various embodiments, such modifications are anticipated and expected and do not depart from the spirit and scope of the present invention.

1. A method for producing a shelf-stable alcoholic ice cream product, the method comprising the steps of:
a. mixing water, an ice cream product, and an alcoholic beverage together to produce a mixture;
b. and heating the mixture to a temperature in the range of about 170-180° F. for a minimal time sufficient to produce a shelf-stable alcoholic ice cream product.

2. The method of claim 1, wherein the step of heating the mixture comprises heating the mixture for about 5-9 minutes.

3. The method of claim 1, wherein the mixture further includes a pH lowering agent.

4. The method of claim 3, wherein the pH lowering agent is citric acid.

5. The method of claim 1, wherein the mixture further comprises additional flavoring agents.

6. The method of claim 5, wherein the additional flavoring agent contains sugar.

7. The method of claim 1 further comprising the step of placing the heated mixture in a container, the container being heated to at least 170° F., holding the temperature at a minimum temperature of about 170° F. for a period of time, and sealing the container.

8. The method of claim 7, wherein the container is at least one of a bottle and a foil pouch.

9. The method of claim 1 wherein the shelf-stable alcoholic product is gelato.

10. The method of claim 1 wherein the ice cream product is a non-dairy ice cream mix.

11. The method of claim 1 wherein the alcoholic ice cream product is 6.5-9.5% alcohol by volume.

12. The method of claim 1 wherein the alcoholic beverage is at least one sweet wine.

13. The method of claim 1, comprising about 33% ice cream mix, about 33% water and about 33% sweet wine.

14. The method of claim 13 wherein the sweet wine has an alcohol content of about 12-22% by volume.

15. A product produced by the method of claim 1.

16. A shelf-stable alcoholic ice cream product comprising a mixture of:
a. water;
b. an ice cream product; and
c. at least one alcoholic beverage, whereby the mixture is shelf-stable.

17. The shelf-stable alcoholic ice cream product of claim 16 further comprising at least one flavorant.

18. The shelf-stable alcoholic ice cream product of claim 16, comprising at least one of red wine, sweet wine, white wine, or combinations thereof.

19. The shelf-stable alcoholic ice cream product of claim 16 further comprising at least one acidifying agent.

20. The shelf-stable alcoholic ice cream product of claim 16 comprising about 33% ice cream mix, about 33% water and about 33% wine.

21. The shelf-stable alcoholic ice cream product of claim 16 wherein the at least one alcoholic beverage is a sweet wine comprising about 12-22% of alcohol by volume.

22. The shelf-stable alcoholic ice cream product of claim 16 wherein the product is a shelf-stable liquid beverage.

23. The shelf-stable alcoholic ice cream product of claim 16 comprising an alcohol concentration of about 5.5-9.5% by volume.

24. A shelf stable alcoholic infused ice cream product comprising a mixture of:
a. water;
b. a gelato mix;
c. red wine with an alcohol content of about 16% by volume;
d. flavorants; and
e. white wine with an alcohol content of about 16% by volume,
f. whereby the product is shelf-stable,
g. the product comprises an alcohol content in the range of about 5.5-9.5% by volume, and
h. the product comprises about 33% water, about 33% gelato mix, and about 33% total wine content.

25. A method for producing a shelf-stable alcoholic ice cream product, the method consisting essentially of the following steps:
a. mixing water, an ice cream product, and an alcoholic beverage together to produce a mixture;
b. and heating the mixture to a temperature in the range of about 170-180° F. for about 7 minutes to produce a shelf-stable alcoholic ice cream product.
